(19) United States
(12) Patent Application Publication
(10) Pub. No.: US 2006/0054387 A1
(43) Pub. Date: Mar. 16, 2006

(54) Saftey harness

(76) Inventor: Paul-Emile Fortin, Ste-Foy (CA)

Correspondence Address: INVENTARIUM, Suite 1607, 4050 Rosemont blvd., Montreal, QC, H1X 1M4, CA

(21) Appl. No.: 11/205,827

(22) Filed: Aug. 17, 2005

Related U.S. Application Data
(60) Provisional application No. 60/602,011, filed on Aug. 17, 2004.

(51) Int. Cl. A62B 35/00

(52) U.S. Cl. 182/3

(57) ABSTRACT

A safety harness consists of a harness similar at first glance to other harnesses of the type but with the added feature of a conical waistbelt and specially contoured shoulder pads. The conical waistbelt allows for more weight to be distributed straight on top of the hip bones thus reducing the amount of weight the shoulders must bear. By having less weight on the shoulders, back pain is dramatically reduced. The contouring of the shoulder pads also allows for a greater freedom of movement.

This application claims priority based on provisional patent application 60/602,011 filed Aug. 17, 2004

### BACKGROUND OF THE INVENTION

1. Field of the Invention

The invention relates generally to safety equipment for workers but more specifically to a safety harness.

2. Background of the Invention

As safety laws in the construction industry have become more stringent over the years, it is now mandatory in most of north america for those working in elevated areas to be attached to a safety line. For that purpose various types of belts and harnesses have been developped. Generally, the belt or harness comprises one or more metal loops usualy referred as “D-rings” which are fixedly mounted on the belt or harness in the center back or on each sides. Depending upon the nature of the work, a safety line can be wrapped around a steel beam and hooked to both side D-rings or else, a longer safety line can be attached to a static post or structure inside a building or even to another long fixed line from which several workers can be attached to simultaneously and which allows for greater mobility along the length of a building. In some cases, a bungee like rope can secure a worker with a limited “soft” fall instead of a more traditional abruptly stopped fall which can cause bodily injury from the harness itself.

Although numerous types of harnesses and belts have been developed, a worker generally needs to carry yet another belt to carry tools since the harness only serves to hook the worker to a rope. Those harnesses which also incorporate compartments and attachments for hooking tools fall short when it comes to comfort since the weight is either too much on the waistline or too much on the shoulders which inhibits arm movements and can cause serious back injury over time from straining to support sometimes very heavy equipment over long periods of time.

Because of the variety of jobs such as window washers, telephone linemen and high rise building work, there is a variety of needs that need to be fulfilleed since, for example, telephone linemen usually have a rather static work position where they are leaned slightly backwards from the vertical, which is quite different from the working situation of a bridge worker who usually stands upright and walks about. To this day an adequate harness developed specifically for steel structure workers working on towers, bridges and high rises has yet to be developed.

### SUMMARY OF THE INVENTION

It is a first object of this invention to provide for a harness having a unique weight distribution around the waistline.

It is a second object of this invention to provide for a harness having specially contoured shoulder supports.

In order to do so, the present invention consists of a harness similar at first glance to other harnesses of the type but with the added feature of a conical waistbelt and specially contoured shoulder pads. The conical waistbelt allows for more weight to be distributed straight on top of the hip bones thus reducing the amount of weight the shoulders must bear. By having less weight on the shoulders, back pain is dramatically reduced. The contouring of the shoulder pads also allows for a greater freedom of movement.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

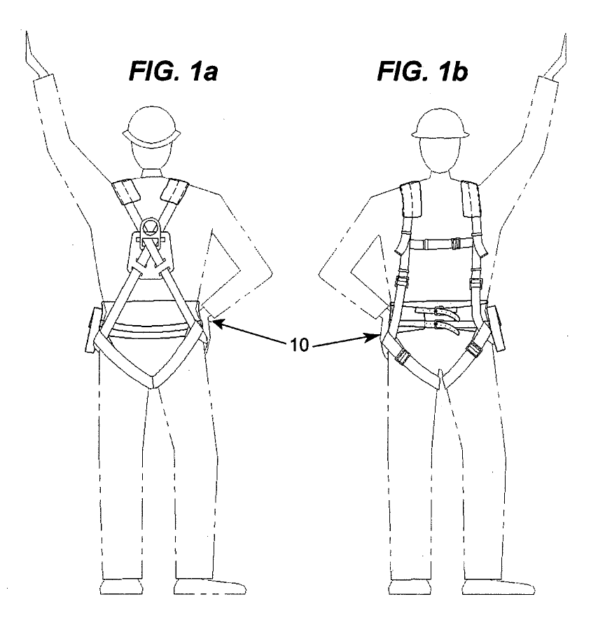

FIGS. 1ab Front and rear view of the invention in context respectively.

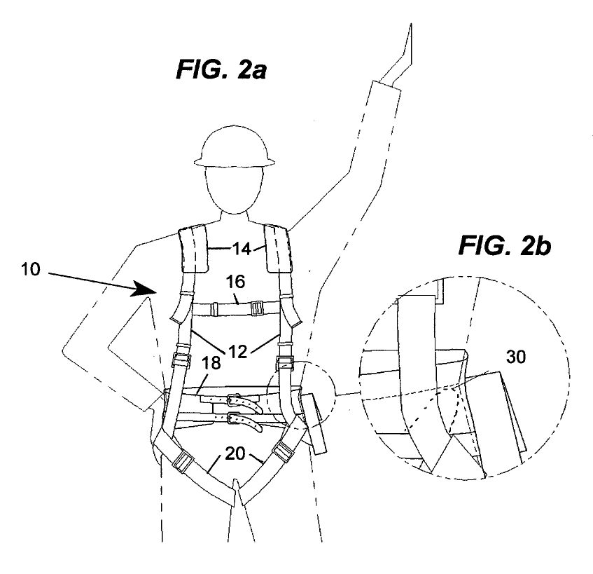

FIG. 2ab Front view with close up detail respectively.

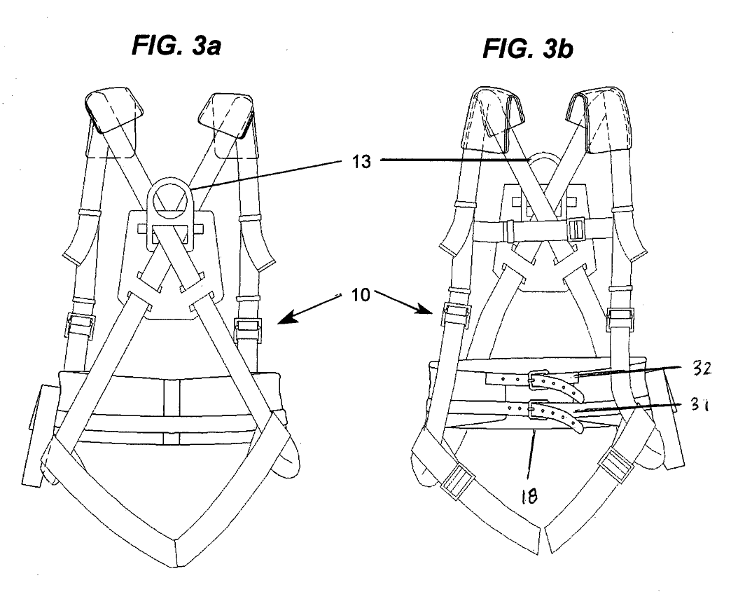

FIGS. 3ab Perspective views favoring the front and the rear respectively.

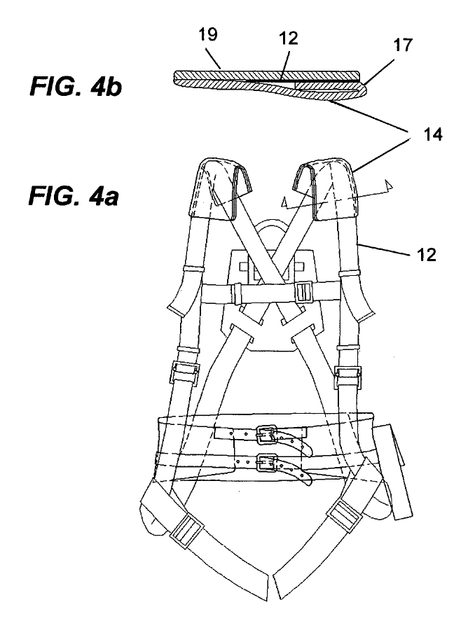

FIGS. 4ab Perspective view favoring the front and crossectional view of the shoulder pad respectively.

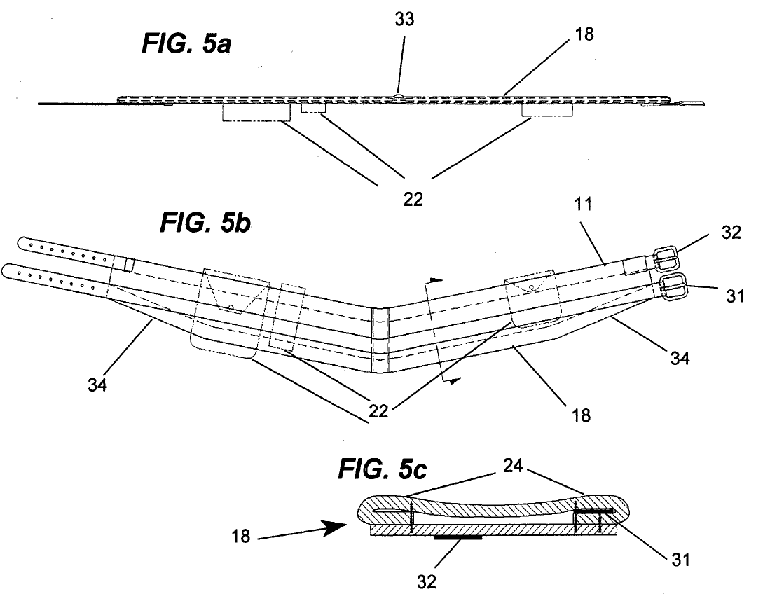

FIGS. 5abc Side view, front view and crossectional view respectively.

### DETAILED DESCRIPTION OF THE PREFERRED EMBODIMENT

A safety harness (10) has suspenders (12) equipped with contoured shoulders pads (14) and a chest strap (16). At the lower end of the suspenders (12) is a conical belt (18) and below the conical belt (18) are leg straps (20). The suspenders (12), chest straps (16) and leg straps (20) are known in the art. The conical belt (18) is so shaped so that it can rest on top of the hip bones (30). In so doing, there is a better weight distribution between the shoulders and the hips of a user. Some workers complain that having too much weight on the hips causes lower back pain, slows blood circulation which induces numbness and too much weight on the shoulders impedes arm motion and causes upper back pain. To adjust the conical shape of the belt (18), a system of a lower belt (31) and an upper belt (32) adjusts a top part (11) of the conical belt (18) so that it increases or decreases its conical shape until a just balance of support and comfort is achieved. The shoulders pads (14) are specially contoured, by a fold (15), so that they are thicker towards art outside edge (17) than an inside edge (19) so as to conform the the rounded shape of a user's shoulders (21) and thus offer better weight distribution.

As is known in the art, the conical belt (18) is also capable of carrying a plurality of tools and pouches (22) according to the nature of the work done by the user. The conical belt also uses folding (24) for additional cushioning against the hip bones (30). The conical belt, when laid flat, assumes a V shape as shown in FIG. 5b and has a cut (34) so that the front of the conical belt (18) is generally less wide than the rest of the conical belt (18) so as to facilitate leaning forward by the user. The V shape is what creates the conical shape of the conical belt (10) by making the conical belt (10) narrower at the top part where the upper belt (32) is situated. By firstly adjusting the lower belt (31) for comfort around the waist and then tightening the upper belt (32) somewhat more, a conical shape is created. This conical shape is varied according to the degree at which the upper belt (32) is tightened in relation to the lower belt (31). It should be understood that a user can tighten the upper belt (32) first and then the lower belt (31) and still achieve the desired result. Also, a boss (33) on the inside of the conical belt (10) aligns with the backbone of a user.

Other elements used on similar types of harnesses, such as a D-ring (13) attached to the suspenders (12) are also present and will not be discussed since it should be understood that all the standard elements generally included in harnesses of this type are de facto included in this safety harness (10).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A safety harness having a belt, suspenders, shoulders pads, a chest strap and leg straps and further comprising:
a belt that is a conical belt;
said conical belt so shaped that it can rest on top of hip bones;
a system of a lower belt and an upper belt to adjust a top part of said conical belt so that it increases or decreases its conical shape until a just balance of support and comfort is achieved.

2. A safety harness as in claim 1 wherein:
said shoulders pads being contoured by a fold so that they are thicker towards an outside edge than an inside edge so as to conform the the rounded shape of a user's shoulders.

3. A safety harness as in claim 1 wherein:
said conical belt having a folding for additional cushioning against hip bones.

4. A safety harness as in claim 1 wherein:
said conical belt, when laid flat, assuming a V shape, said V shape creating the conical shape of said conical belt.

5. A safety harness as in claim 1 wherein:
Said conical belt having a cut so that the front of the conical belt is generally less wide than the rest of the conical belt so as to facilitate leaning forward by a user.

6. A safety harness as in claim 1 having the following method of installation:
a conical shape in said conical belt is created and changed according to the degree at which an upper belt is tightened in relation to a lower belt, wherein the tighter said upper belt is tightened in relation to said lower belt, the more conical the shape of said conical belt is.
